(19) United States
(12) Patent Application Publication
(10) Pub. No.: US 2015/0298797 A1
(43) Pub. Date: Oct. 22, 2015

(54) Aircraft Having A System For Influencing The Yaw Moment And A Method For Influencing The Yaw Moment Of An Aircraft

(71) Applicant: Airbus Operations GmbH, Hamburg (DE)

(72) Inventor: Hendrik Friedel, Weyhe (DE)

(73) Assignee: Airbus Operations GmbH, Hamburg (DE)

(21) Appl. No.: 14/181,797

(22) Filed: Feb. 17, 2014

Related U.S. Application Data
(60) Provisional application No. 61/765,844, filed on Feb. 18, 2013.

(30) Foreign Application Priority Data
Feb. 18, 2013 (DE) 10 2013 101 602.2

(51) Int. Cl. B64C 15/14; B64C 13/50; B64C 13/16

(52) U.S. Cl. CPC B64C 15/14; B64C 13/16; B64C 13/50

(57) ABSTRACT

An aircraft includes a system for influencing the yaw moment. The system includes a thrust generation means, an energy store which can be coupled to the thrust generation means for transmitting energy to the thrust generation means, and a trigger device. The thrust generation means is set up so as to provide a thrust force, including a thrust direction vector at a distance from a yaw axis of the aircraft. The trigger device is set up to couple the energy store to the thrust generation means at least for a predetermined period T on demand. The ability to compensate part of the thrust asymmetry independently of a rudder unit if an engine fails means that the rudder unit can be configured with smaller dimensions. This leads to a considerable reduction in the aerodynamic resistance of the aircraft, and thus to a weight-equivalent advantage, without leading to safety compromises.

### CROSS-REFERENCE TO RELATED APPLICATIONS

This application claims the benefit of the filing date of U.S. Provisional Patent Application No. 61/765,844 filed Feb. 18, 2013, the disclosure of which is hereby incorporated herein by reference.

### TECHNICAL FIELD

The invention relates to an aircraft comprising a system for influencing the yaw moment and to a method for influencing the yaw moment of an aircraft.

### BACKGROUND OF THE INVENTION

The flight attitude, in other words the spatial orientation of an aircraft during flight, is generally dependent on a plurality of parameters such as flight speed, altitude, the arrangement of tail units and the position of control surfaces. Tail units and control surfaces are dimensioned taking into account the desired flight performances, which in turn depend in part on regulations such as JAR and FAR. For example, the dimensioning of a rudder unit of an aircraft comprising a plurality of eccentrically arranged engines is subject to the requirement of being able to compensate an engine failure and a resulting thrust asymmetry. Because of the low flight speeds when the aircraft takes off, the necessary area of the rudder for the yaw moment compensation is relatively large, even though it could be dimensioned smaller for all other flight phases at higher flight speeds. As a result, the rudder unit is also relatively large and produces a correspondingly large flow resistance throughout the flight.

EP 10 26 565 B1 discloses a device for controlling a yaw angle of an aircraft.

### BRIEF SUMMARY OF THE INVENTION

It would be desirable to reduce the air resistance of an aircraft so as to improve the efficiency thereof. At the same time, it is necessary always to be able to ensure complete control of the flight attitude of the aircraft.

An aircraft comprising a system for influencing the yaw moment is proposed, the system comprising a thrust generation means, an energy store which can be coupled to the thrust generation means for transmitting energy to the thrust generation means, and a trigger device. The trigger device is set up so as to couple the energy store to the thrust generation means at least for a predetermined period T on demand. The thrust generation means is set up so as to provide an independent thrust force, comprising a thrust direction vector which is at a distance from a yaw axis of the aircraft, by drawing energy from the energy store, so as at least to reduce a thrust asymmetry of the aircraft.

This may provide for an aircraft which is capable of controlling a flight attitude even in a case of asymmetric thrust due to an engine failure, even though the rudder unit and the rudder are of a reduced size.

A central idea of the aircraft according to an exemplary embodiment the invention is, if the rest of the thrust is provided asymmetrically as a result of an engine failure, to generate at least temporarily by way of a thrust generation means an additional thrust force which, as a result of a suitable position and orientation of the associated thrust vector and the distance thereof from the yaw axis of the aircraft, can lead to a yaw moment which counters a thrust asymmetry. The additional thrust force need not act in the same direction as the rest of the thrust, so long as the direction of rotation about the yaw axis is counter to the asymmetry. Therefore, complete compensation of the asymmetry exclusively by way of the rudder unit and the rudder is not necessary at least for a period T, and so the dimensioning can be adapted to this.

As a result of providing the additional thrust force to compensate the asymmetry, continuous acceleration can be achieved in spite of an engine failure, in particular when the aircraft is taking off, and leads to a higher speed of the aircraft and therefore to a greater impact pressure on the rudder unit and thus to improved efficiency of the rudder unit and rudder. If the aircraft is for example involved in a take-off process in which an engine fails, continuous acceleration could still be provided while temporarily compensating the asymmetry, and makes it possible to return the aircraft for landing once a particular boundary speed (V_{min control}) is reached.

The thrust generation means may comprise any desired types of thrust generation means which can provide a thrust force by drawing energy. It is preferred to use a pre-existing thrust generation means of the aircraft so as to provide the temporary compensation of the yaw moment.

The energy store may further be configured in any desired manner so long as a sufficient amount of energy, which is enough for temporary operation of the thrust generation means, can be provided by the store and again on demand. The type of stored energy depends on the type of thrust generation means or the nature of the coupling of the thrust generation means and the energy store, and may in particular include kinetic, potential, chemical or electrical energy.

The trigger device may bring about a coupling between the thrust generation means and the energy store on request by a pilot or on the basis of a predetermined operating factor. The operating factor may for example be the rotational speed ratio of the engines to one another. The thrust generation means is brought into operation by the coupling, and temporarily generates an additional thrust, which leads to compensation of or reduction in the asymmetry.

It may therefore be possible to configure the rudder unit with smaller dimensions, leading to a considerable reduction in the aerodynamic resistance of the aircraft. The reduction in fuel consumption which is thus achieved and the lower fixed weight of the rudder unit lead to an equivalent saving in weight, which is much greater than the fixed weight of the components required for the system. This greatly increases the efficiency of the aircraft without leading to safety compromises.

An air conveyor device of an engine of the aircraft may be used as the thrust generation means. An air conveyor device is dependent on the construction of the engine, and could comprise a propeller and one or more fans. Particularly preferably, the engine is set up so as to decouple the air conveyor device from the remaining components of the engine. When the air conveyor device rotates, it is not necessary for engine shafts, turbine stages or similar components to be entrained, and so the energy from the energy store is preferably only used for driving the air conveyor device, increasing the efficiency of the system.

In an exemplary embodiment, the energy store comprises a flywheel device comprising a rotatably mounted flywheel. The flywheel device may be connected via a releasable coupling to a fan of a turbojet engine, to another air conveyor device or to a completely different thrust generation means. In a particularly preferred embodiment, the aircraft comprises a plurality of turbojet engines, which are each equipped with a flywheel device, in such a way that every engine failure can be taken into account. The fan of the turbojet engine can be rotated by way of coupling to the flywheel device, so as to provide a thrust force in the manner of an impeller. For this purpose, the flywheel device comprises a flywheel which can absorb kinetic energy by rotating and, if mounted suitably, can store said energy by maintaining the rotation. The kinetic energy is released in that the flywheel is mechanically connected to the thrust generation means. To minimise the necessary external diameter of the flywheel used, it is advantageous to provide a particularly high rotational speed. As a result of the large diameter of the fan of a turbojet engine and the resulting inertia, the use of a reduction gear unit to drive the thrust generation means is further preferred.

The system may comprise a mechanical coupling unit for coupling the flywheel unit and the thrust generation means. All known forms of mechanical coupling unit are possible which can produce a releasable connection between two components which rotate or can be driven in rotation. An actuator for producing and releasing the connection may be integrated into the coupling unit or coupling so as to provide simple actuation from the outside. Because the thrust generation means and the flywheel unit can be connected, kinetic energy can be transmitted to the flywheel unit for charging before the aircraft takes off by way of normal operation of the thrust generation means.

The mechanical coupling unit may be set up so as to make slippage continuously possible between the thrust generation means and the flywheel unit. To charge a flywheel device, it is necessary to rotate a flywheel contained in the flywheel device. If the flywheel device is arranged on an engine, it would be desirable to make sufficient slip possible so as not to load a shaft connected to the engine excessively, so as to take into account the inertia of the flywheel device, and so as to reduce the load on the driving engine. For example, it would be advantageous to integrate a torque converter for this purpose.

Alternatively or in addition, the system may comprise an electric motor which can be connected to the flywheel unit for transmitting kinetic energy to the flywheel unit. The electric motor could be configured as a brushless DC motor or as an AC-powered asynchronous motor, which always make slip possible during operation.

The energy store may further be configured as a store for electrical energy, the thrust generation means comprising an electric motor which generates a thrust force or rotates an air conveyor device by drawing electrical energy. A store for electrical energy may comprise a device which can store a limited amount of electrical energy and release it again completely with small losses in as limited a time as possible, in particular at a high electrical power. Suitable energy stores could in particular comprise capacitors or supercapacitors, but may also be configured as conventional rechargeable batteries.

The thrust generation means may be configured as an air conveyor device which is arranged in a position of the aircraft at a distance along the longitudinal axis thereof from the yaw axis of the aircraft and which is set up so as to provide a thrust force of which the thrust vector extends parallel at least in part to a transverse axis of the aircraft. The expression “parallel at least in part” should be understood to the effect that a substantial component of the thrust vector extends parallel to the transverse axis. The thrust generation means thus provides as required a transverse force which leads to compensation of the yaw moment as a result of the distance from the yaw axis. The thrust direction of the thrust generation means is set as a function of the asymmetry. The advantage of an arrangement of this type is that the effective lever length of the thrust generation means, as the distance of the thrust vector from the yaw axis, can be much greater than if air conveyor devices of the engines are used. The amount of energy required for operating the system can thus be smaller, and this leads to a lower weight. Further, only one thrust generation means is necessary, since the direction of the thrust vector is selectable.

The thrust generation means may be arranged in the tail of the aircraft in the form of an impeller or a peripherally encapsulated ducted fan, for example directly alongside, on, below, in front of, behind or in a rudder unit. Because of the possibility of a large lever distance from the yaw axis, a relatively large compensating yaw moment can be generated using a relatively small force.

For operating the thrust generation means, it is possible to use an electric motor such as electric hub drive, the direction of rotation of which can be set as required using an electrical control system. It would also be conceivable to set the blade angle of the impeller to change the direction of rotation or to use a transmission which changes the direction of rotation. In this case, the energy store would accordingly be an electrical energy store.

Alternatively, if an impeller is used, it would also be conceivable to implement the energy store as a flywheel unit which can be connected to the thrust generation means via a shaft connection. In this context, the flywheel unit requires an angle gear which, alongside a gear reduction unit which may be necessary, could further make it possible to switch the direction of rotation. However, changing the blade angle would also be an alternative. The flywheel unit may be located outside the range of the thrust generation means and carry out a rotation about an axis which is preferably positioned in the x-z plane of the aircraft. Since the thrust generation means preferably carries out a rotation perpendicular to the x-z plane, a corresponding angle gear is necessary, and is arranged for example directly on a hub of the thrust generation means. A shaft which is connected to the flywheel unit via a preferably releasable coupling may extend between the flywheel unit and the angle gear. The trigger device may further be set up so as to carry out or initiate switching of the direction of rotation as required. For charging the flywheel unit to store kinetic energy, an electric motor integrated into said flywheel may be suitable for carrying out a rotation of the flywheel in the flywheel unit by drawing electrical energy from an on-board system of the aircraft prior to a take-off phase. Alternatively or in addition, it is possible to produce a connection to an auxiliary engine via a releasable mechanical coupling and a shaft connected thereto, said engine often being located in a tail region of the aircraft and conventionally being operated before the aircraft takes off.

The release device may be set up so as to detect an asymmetric thrust situation and to initiate a rotation of the thrust generation means by drawing energy from the energy store if a predetermined degree of asymmetry is exceeded. The detection may for example take place in that a corresponding signal is received from an on-board computer of the aircraft which is aware of the failure of an engine. The detection may further comprise evaluating rotational speed signals from the engines. Alternatively or in addition, the trigger device may receive a signal from a pilot who requests temporary compensation of the yaw moment if an engine fails.

The invention further relates to a method for influencing the yaw moment of an aircraft having the features of the further independent claim and of the following description.

The method comprises the steps of detecting an asymmetric flight situation, transmitting energy from an energy store to a thrust generation means, and continuously generating thrust by way of the thrust generation means at a thrust direction vector which is at a distance from the yaw axis of the aircraft, at least for a predetermined period T, by drawing energy from the energy store. If an engine fails at low speed, the temporary generation of thrust can compensate the yaw moment balance at least in part.

In an exemplary embodiment, the thrust is only generated by the thrust generation means if the speed of the aircraft is below a predetermined minimum speed. This speed may for example correspond to the speed v_{min control} specified in the regulations, which corresponds for example to 1.2 times the stall speed. The speed can be detected by detecting a flight speed value which is stored centrally in an air data system, or alternatively or additionally by way of a separate sensor associated with the system.

The method according to an exemplary aspect of the invention also comprises charging the energy store prior to the flight of the aircraft. In this way, the energy store is prepared for the unlikely application thereof.

Particularly, the method may comprise recharging the energy store after the energy store is discharged or after the generation of thrust by the thrust generation means is over. This takes into account the use situation where, if additional thrust is generated, the aircraft has a speed which makes landing possible. For landing, a reduction in speed is necessary, and this in turn means that the asymmetry cannot be fully compensated by a rudder unit having reduced dimensions. For this purpose, it would again be necessary to generate an additional thrust force which compensates the yaw moment balance. For this purpose, the energy store has to be recharged.

Charging the energy store may comprise connecting a flywheel device to a drive unit via a coupling, preferably for a duration lasting until the flywheel device achieves a configuration rotational speed. The drive unit may, as stated above, be an engine or an electric motor.

### BRIEF DESCRIPTION OF THE DRAWINGS

Further features, advantages and possible applications of the present invention may be taken from the following description of the embodiments and the drawings. In this context, all of the features which are disclosed and/or shown in the drawings, per se and in any desired combination, form the subject-matter of the invention, irrespective of how they are combined in the individual claims or the dependencies thereof. Further, in the drawings, like reference numerals denote like or similar objects.

FIG. 1a to 1c show an aircraft comprising a system for influencing the yaw moment, in which thrust generation means are integrated into primary engines.

FIGS. 2a to 2d show an aircraft comprising a system for influencing the yaw moment, in which a thrust generation means is configured separately from the primary engines.

FIG. 3 is a schematic block diagram showing a method for influencing the yaw moment of an aircraft.

### DETAILED DESCRIPTION

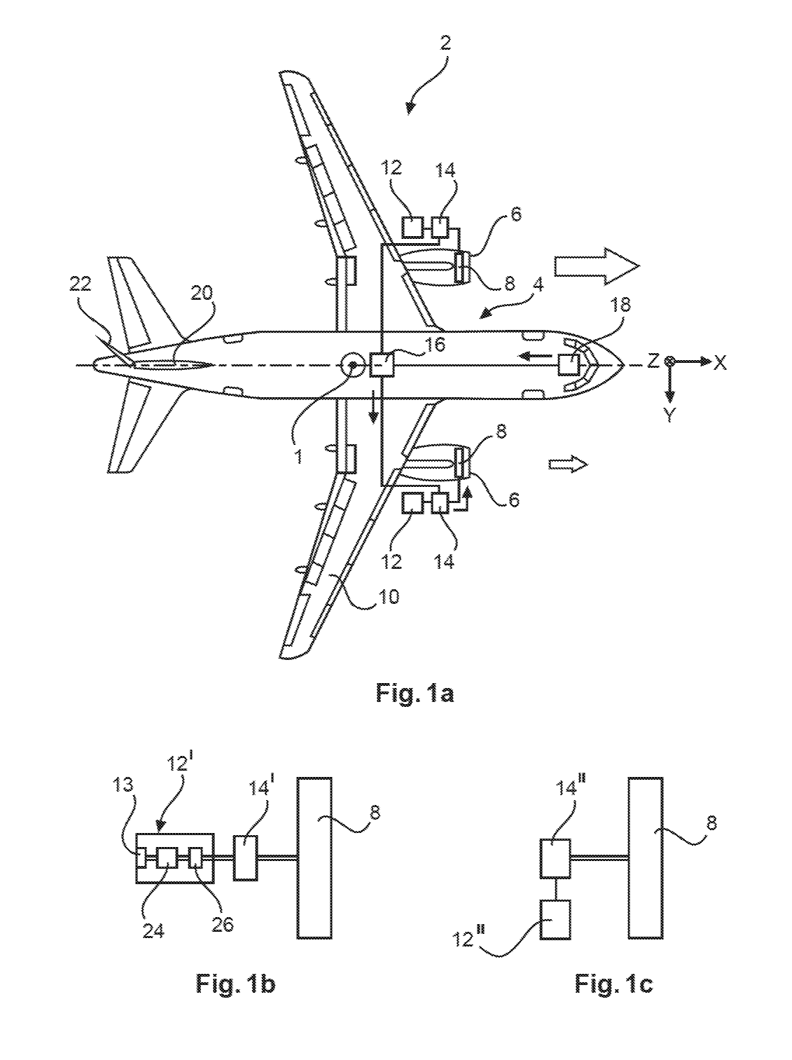

FIG. 1a shows an aircraft 2 comprising a system 4 for influencing the yaw moment about a yaw axis 1 in a first, simple embodiment. By way of example, the aircraft 2 comprises two turbojet engines 6, which are each equipped with a fan 8 for generating a sheath current. The engines 6 are arranged off-centre and symmetrically about a longitudinal axis of the aircraft 2 on the underside of the aerofoil 10, and supply a thrust force in the x-direction parallel to the longitudinal axis when both engines 6 are in operation. The system 4 further comprises an energy store 12 for each fan 8, which can be connected to the respective fan 8 via a coupling unit 14, and a trigger device 16, which is connected to both coupling units 14. For this purpose, the energy stores 12 are set up so as to store a limited amount of energy and release it to the respective fans 8 via the coupling unit 14 so as to drive them as thrust generation means. The terms “fan” and “thrust generation means” should therefore be considered synonymous for this embodiment. Therefore, when the energy store 12 is connected via the coupling unit 14, a thrust force can be provided, the duration of which depends on the size of the energy store 12.

As a result of the energy store 12 being coupled via the coupling unit 14, a rotation of the respective fan 8 is therefore carried out, the coupling being controllable via the trigger device 16, which can receive a trigger signal from a control unit 18. In this context, the control unit 18 may be both an on-board computer and an operating unit which is operated by a person. If one of the engines 6 fails, resulting in an asymmetric thrust-induced yaw moment about the yaw axis 1, the system 4 is able to supply thrust assistance for a short time, which generates an additional yaw moment in the other direction of rotation, which counters the asymmetrically acting yaw moment if an engine fails. The yaw moment balance of the aircraft 2 can thus be compensated at least in part, without a rudder unit 20 of the aircraft 2 having to be excessively large or a rudder 22 having to be fully deflected.

Since the system 4 is coupled to the fans 8 of the engines in the variant shown, the thrust loss resulting from the engine failure is reduced, as well as a yaw moment which counters the asymmetry being generated. This thrust assistance is expedient in particular at low speeds, at which the rudder unit 20 is merely exposed to a low impact pressure and therefore is not very effective. Particularly if an engine fails while the aircraft 2 is taking off, the aircraft should still be able to accelerate relatively rapidly to a minimum speed V_{min control}, which makes it possible to return safely to the airport.

FIG. 1a shows the failure of the right engine 6, the left engine 6 supplying a full thrust force (denoted by a larger thrust arrow) whilst the system 4, at the request of a control unit 18 from the trigger device 16, induces a coupling of the energy store 12 to the fan 8 via the coupling unit 14. As a result, by rotating the fan 8, an additional thrust force is provided as a “boost” for a short time. So as to provide an efficient, lightweight yet highly effective configuration of the system 4, the energy store 12 can be dimensioned in such a way that, although not the entire, originally achieved thrust force of the failed engine is generated, the yaw moment balance is still compensated when a rudder 22 of a rudder unit 20 which is smaller than usual is deployed, and the prescribed boundary speed is reached within a predetermined distance from take-off.

The energy store 12 may be implemented in various ways. By way of example, FIG. 1b shows an energy store 12′ in the form of a flywheel device comprising a flywheel 24 and a reduction gear unit 26, which can be connected as required to the thrust generation means 8 via a coupling 14′ as a coupling unit. The coupling 14′ is a mechanical coupling which provides rotational power between the flywheel device 12′ and the thrust generation means. After the engines 6 are started, the flywheel device 12′ can be driven via the coupling 14′ by rotating the fan 8, in such a way that the flywheel 24 reaches a predetermined rotational speed, which represents a stored kinetic energy. Once the rotational speed is reached, the coupling 14′ can be released and the system 4 is ready for use. Alternatively, an electric motor 13 may also be used, and can be connected to the flywheel 24 preferably via a releasable coupling, a freewheel or similar devices, in such a way that coupling to an engine 6 is not necessarily required.

The coupling 14′ may comprise a torque converter, in such a way that the outputted torque is continuously adapted while constantly increasing or maintaining the rotational speed so as to drive a larger fan 8 using a flywheel 24. The slip achieved in this manner makes it possible to improve the service life of the connecting shafts between the flywheel 24 and the fan 8. Further, it would also be conceivable to use a simple mechanical coupling having two discrete switching states, for example in the form of a lamella or disc coupling, which makes a particular slip possible for a short period of time, but reaches the desired rotational speed relatively rapidly during the use of the system 4 and can be maintained for the predetermined period. Storing kinetic energy using a flywheel unit 12′ is possible because kinetic energy need not be converted into other forms of energy for storage, but can be put to further use directly, ensuring high efficiency.

If a flywheel unit 12′ is used for driving a fan 8, a plurality of operating options would be conceivable. On the one hand, as stated above, the flywheel unit 12′ could be dimensioned in such a way that operating the fan 8 provides the entire thrust force of the failed engine 6. For a two-jet medium-range aircraft, energy of 250 MJ might be necessary so as to supply the required additional thrust to reach a minimum speed if the aircraft takes off with a failed engine 6. The weight of the two installed flywheel units 12′ could be in a range around 500 kg, by which amount the weight of the aircraft 2 therefore increases. However, the minimum speed is reached more rapidly as a result of the greater thrust. This also reduces the amount of energy to be stored in the flywheel units 12′. The rudder unit can be of smaller dimensions as a result of the lower requirements, and this not only reduces the weight thereof, and thus in turn compensates the additional weight of the flywheel units 12′ in part, but also leads to a lower aerodynamic flow resistance. This brings about a weight-equivalent advantage, which more than compensates the overall increase in weight of the aircraft 2.

On the other hand, a lower thrust force may also be generated by the fan 8, for example 50% of the original thrust of the failed engine 6. This reduces the amount of energy to be stored, and thus the additional weight of the flywheel units 12′, to approximately half. By changing the dimensioning of the rudder unit 20, the additional weight can be further reduced. In this case too, a weight-equivalent advantage should be expected as a result of reducing the size of the rudder unit 20, and is much greater than the additional weight. In this case too, the minimum speed is reached more rapidly and the required amount of energy is thus reduced.

A mechanically simpler solution is shown in FIG. 1c, in which a motor generator unit 14″ is used as a coupling unit 14, which may already be present in modern engines 6 to generate electrical power for supplying electrical consumers or for starting engines 6 by drawing electrical power. Electrical energy is therefore supplied during the operation of the engine 6, and is stored in an electrical energy store 12″. If the relevant engine 6 fails, the motor generator unit 14″ can be used on demand to rotate the fan 8 by drawing the energy from the energy store 12″. For a suitably selected motor generator unit 14″, a balanced ratio of rotational speed and torque can be brought about, causing a drive which is gentler on the materials to be achieved. The energy store 12″ may equally be in the form of a storage battery or a rechargeable battery or in the form of a very-high-capacitance capacitor, known as a supercapacitor.

Generally, in the embodiments of FIGS. 1a, 1b and 1c, it should be noted that the fan 8 is connected to other devices of the engine 6, and in particular turbine stages and compressor stages, in a conventional manner via a rigid shaft connection. So as to reduce the energy to be stored in the energy stores 12, to protect the engine and to take into account any jamming within the engine, a device may be provided which makes selective rotation exclusively of the fan 8 of an engine 6 possible. If the coupling unit 14 is connected directly to the fan 8 and not to an engine shaft, the fan 8 can be separated from the remaining units by a suitable coupling and in particular by a freewheel. A connection between a coupling unit 14 and a fan 8 could be provided at the periphery by way of a crown gear and a pinion which engages therein or by way of a friction fit. Alternatively, it would be conceivable for this purpose to dimension the energy store 12 in such a way that the stored energy is sufficient to make it possible for the entire engine 6 to rotate for the predetermined period.

The trigger device 16 is set up so as to couple the coupling unit 14 to the fan 8 as a result of a corresponding signal, which originates from a switch setting or from a signal from an on-board computer or a control unit. If the energy store 12 is in the form of a mechanical energy store, the trigger device 16 can emit a control signal which actuates a mechanical, electrically operable coupling unit or alternatively may comprise an electric or hydraulic actuator which activates the coupling unit 14′. If the storage unit 12 is an electrical storage unit, the trigger device 16 may consist of power electronics, which set a motor or a motor generator unit into operation as a coupling unit 14″ upon receiving a corresponding signal.

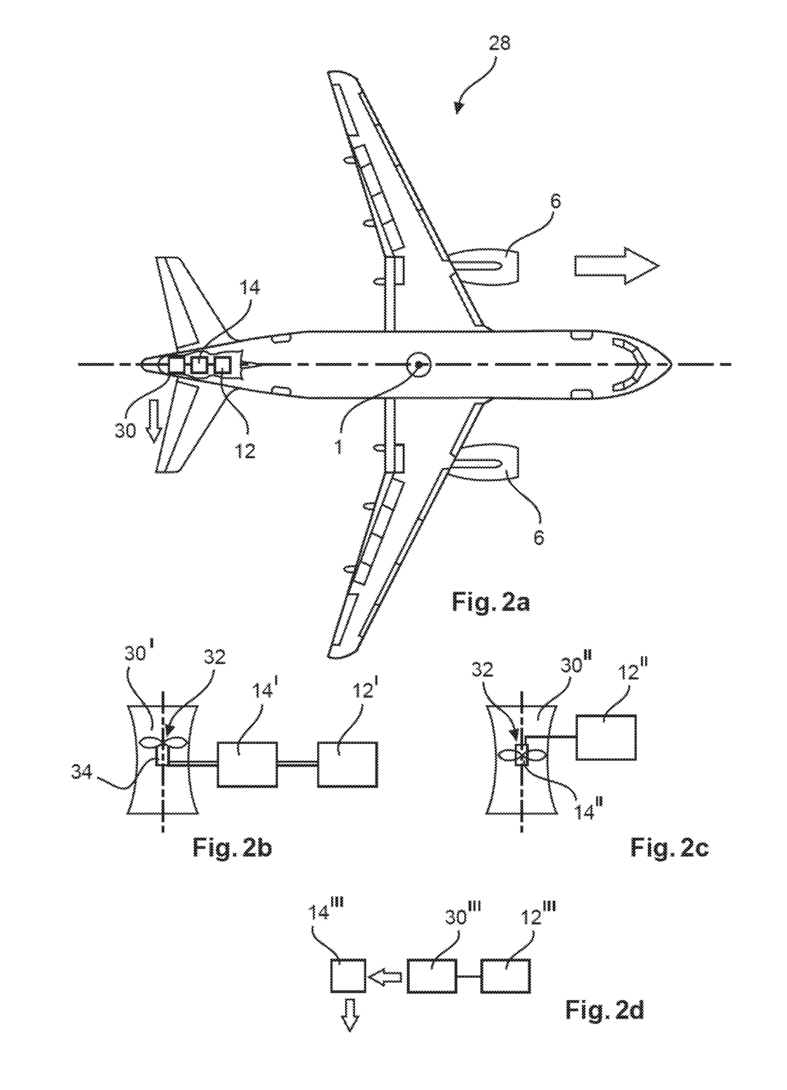

FIG. 2a shows an aircraft 28 which is likewise equipped with two engines 6. For clarity, the trigger device 16 and the operating unit 18 are not explicitly shown. These may be configured and connected to the coupling unit 14 as shown in FIG. 1a.

By way of example, in this case too, of the two engines 6 it is the one on the right which has failed, in such a way that the aircraft 28 is experiencing an asymmetric thrust exclusively from the left engine 6. Alongside the rudder unit 20 and the rudder 22, a thrust generation means 30 serves to compensate the asymmetry, and in this embodiment is located in a tail region of the aircraft and by way of example in a tail cone. The thrust generation means 30 is set up so as to provide a thrust substantially parallel to the y-axis of the aircraft 28. As a result of the relatively large distance from the yaw axis 1, a particularly high yaw moment, which counters the asymmetric yaw moment, can still be generated using a relatively low thrust force.

According to FIG. 2b, the thrust generation means 30 is for example an impeller 30′, which can be driven via an angle gear 34 in an impeller hub 32, which angle gear is connected via a shaft 35 to a coupling unit 14′. This may be configured in the form of a mechanical coupling, which transmits a rotation of an energy store, in the form of a flywheel unit 12″, to the impeller 30′. To ensure the correct thrust direction, the impeller 30′ may be set up so as to alter blade angle directions; alternatively, the coupling unit 14′ may also be set up so as to change the direction of rotation by way of an integrated reduction gear unit.

According to FIG. 2c, the thrust generation means is likewise configured as an impeller 30″ which comprises an electric motor 14″ as a coupling unit, which for example is arranged in an impeller hub 32 and can be operated electrically. The trigger device which can be connected thereto may likewise consist of power electronics, as in FIG. 1c. An energy store 12″ could accordingly be configured as an electrical energy store as in FIG. 1c. Depending on the direction of the asymmetry of the yaw moment, the electric motor 14″, by pole reversal, or the impeller 30″, by changing the blade angle, can provide a reversal of direction.

In a completely different alternative according to FIG. 2d, the thrust generation means 30 is in the form of an auxiliary engine 30′″, which is connected to an energy store 12′″ in the form of a fuel reservoir via a coupling unit 14′″ for fuel supply. The coupling unit 14′″ may simultaneously be set up so as to deflect an exhaust jet of the auxiliary engine 30′″, by means of a flap control system (not shown in detail), so as to generate thrust accordingly in the desired direction.

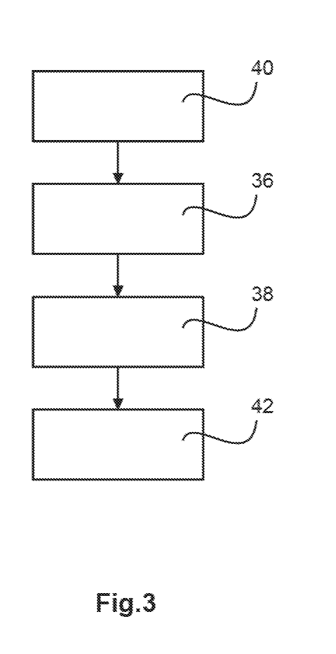

FIG. 3 is a schematic block diagram showing the basic sequence of the method according to the invention. The central idea of the method involves transmitting 36 energy from an energy store via a coupling unit to a thrust generation means on the request of a trigger means. Therefore, thrust is continuously generated 38 by the thrust generation means. The transmission of energy should not be thought of as a single discrete step, but rather as a continuous process like the generation of thrust. This is preceded by charging 40 the energy store, so as to make it possible to operate the thrust generation means independently of other devices of the aircraft for a period T. Since it is expedient to land after carrying out the method, so as to inspect the failed engine, recharging 42 should take place after the energy store discharges, in such a way that if the speed decreases during the landing approach the weaker effectiveness of the rudder unit can again be compensated at least in part by the thrust generation means.

For completeness, it should be noted that “comprising” does not exclude the possibility of other elements or steps, and “an” or “a” does not exclude the possibility of a plurality. It should further be noted that features which were disclosed in the above with reference to one of the above embodiments may also be used in combination with other features of other above-disclosed embodiments. Reference numerals in the claims should not be treated as limiting.

1. An aircraft comprising a system for influencing the yaw moment, the system comprising:
a thrust generation means,
an energy store configured to be coupled to the thrust generation means for transmitting energy to the thrust generation means, and
a trigger device,
wherein the trigger device is configured to couple the energy store to the thrust generation means at least for a predetermined period T, and
wherein the thrust generation means is configured so as to provide an independent thrust force, comprising a thrust direction vector which is at a distance from a yaw axis of the aircraft, by drawing energy from the energy store, so as at least to reduce a thrust asymmetry of the aircraft.

2. The aircraft according to claim 1, wherein the thrust generation means is an air conveyor device of an engine of the aircraft.

3. The aircraft according to claim 1, wherein the energy store comprises a flywheel unit comprising a rotatably mounted flywheel.

4. The aircraft according to claim 3, further comprising a mechanical coupling unit for coupling the flywheel unit and the thrust generation means.

5. The aircraft according to claim 4, wherein the mechanical coupling unit is configured so as to make slippage continuously possible between the thrust generation means and the flywheel unit.

6. The aircraft according to claim 3, further comprising an electric motor configured to be connected to the flywheel unit for transmitting kinetic energy to the flywheel unit.

7. The aircraft according to claim 1,
wherein the energy store is a store for electrical energy, and
wherein the thrust generation means comprises an electric motor which generates a thrust force by drawing electrical energy.

8. The aircraft according to claim 1, wherein the thrust generation means is configured as an air conveyor device which is arranged in a position of the aircraft at a distance along the longitudinal axis thereof from the yaw axis of the aircraft and which is configured so as to provide a thrust force, the thrust vector of which extends parallel at least in part to a transverse axis of the aircraft.

9. The aircraft according to claim 8, wherein the thrust generation means is arranged in the tail of the aircraft in the form of an impeller.

10. The aircraft according to claim 9, wherein the impeller comprises an electric motor and wherein the energy store is a store for electrical energy.

11. The aircraft according to claim 9, wherein the impeller comprises an angle gear configured to be connected to a flywheel unit.

12. The aircraft according to claim 1, wherein the trigger device is configured so as to detect an asymmetric thrust situation and to initiate a drive of the thrust generation means by drawing energy from the energy store if a predetermined degree of asymmetry is exceeded.

13. A Method for influencing the yaw moment of an aircraft, the method comprising:
transmitting energy from an energy store to a thrust generation means on the request of a trigger means, and
continuously generating an independent thrust force by way of the thrust generation means at a thrust direction vector at a distance from a yaw axis of the aircraft, at least for a predetermined period T, by drawing energy from the energy store, so as at least to reduce a thrust asymmetry of the aircraft.

14. The method according to claim 13, comprising charging the energy store before the aircraft takes off.

15. The method according to claim 13, further comprising recharging the energy store during the flight of the aircraft after the generation of thrust force by the thrust generation means is over.
